(19) United States
(12) Patent Application Publication
(10) Pub. No.: US 2019/0389444 A1
(43) Pub. Date: Dec. 26, 2019

(54) Wheel Brake Apparatus

(71) Applicant: Robert Bosch GmbH, Stuttgart (DE)

(72) Inventors: Matthias Kistner, Bretzfeld (DE); Martin Kremer, Grossbottwar (DE)

(21) Appl. No.: 16/446,246

(22) Filed: Jun. 19, 2019

(30) Foreign Application Priority Data
Jun. 22, 2018 (DE) 10 2018 210 236.8

(51) Int. Cl. B60T 11/10; B60T 7/12; B60T 1/06; B60T 13/74; B60W 10/18

(52) U.S. Cl. CPC B60T 11/103; B60T 7/12; B60W 10/182; B60T 13/74; B60T 1/065

(57) ABSTRACT

A wheel brake apparatus for implementing a braking operation via a hydraulic service brake and for implementing a braking operation via an electromechanical parking brake includes at least two pressing elements and a brake caliper. The at least two pressing elements are configured for achieving a braking effect by way of pressing a brake lining against a brake disk. The brake caliper is configured for supporting the at least two pressing elements. The service brake and the parking brake have separate pressing elements. The pressing element of the service brake and the pressing element of the parking brake are attached to the same brake caliper.

This application claims priority under 35 U.S.C. § 119 to patent application no. DE 10 2018 210 236.8, filed on Jun. 22, 2018 in Germany, the disclosure of which is incorporated herein by reference in its entirety.

### BACKGROUND

The disclosure relates to a wheel brake apparatus for implementing a braking operation by means of a hydraulic service brake and for implementing a braking operation by means of an electromechanical parking brake, having at least two pressing elements for achieving a braking effect by way of pressing of a brake lining against a brake disk, having a brake caliper for supporting the pressing elements, the service brake and the parking brake having separate pressing elements, and the pressing element of the service brake and the pressing element of the parking brake being attached to the same brake caliper.

DE 10 2017 219 379 A1 has disclosed a brake system for a vehicle, which brake system comprises a hydraulic vehicle brake and an electromechanical brake apparatus with an electric brake motor. In normal braking operation, the hydraulic vehicle brake is activated, in order to slow down the vehicle. The electromechanical brake apparatus is used as a parking brake and generates a braking force via the electric brake motor for securing the standstill of the vehicle. Here, the electric brake motor of the parking brake acts on the same brake piston as the hydraulic vehicle brake. Via said brake piston, a brake lining on the end side of the brake piston is moved against a brake disk. The wheel brake apparatus is shown in said document as a floating caliper brake, in the case of which a brake piston is configured only on one side.

In a system of this type, in which the parking brake is integrated into the hydraulic system of the service brake, the problem of the tightness of the system results. Furthermore, in the case of brake calipers having a plurality of pistons, there is the necessity to actuate all the pistons by way of the electromechanical actuator of the parking brake, in order to make an optimum introduction of force and contact of the brake lining over the full surface area in order to ensure the braking torque possible.

### SUMMARY

In contrast, the apparatus according to the disclosure advantageously makes an inexpensive solution with low complexity possible. This is made possible by way of the features and further refinements of said features disclosed herein.

According to the disclosure, the wheel brake apparatus for implementing a braking operation by means of a hydraulic service brake and for implementing a braking operation by means of an electromechanical parking brake is configured as follows: having at least two pressing elements for achieving a braking action by way of pressing of a brake lining against the brake disk, having a brake caliper for supporting the pressing elements, the service brake and the parking brake having separate pressing elements, and the pressing element of the service brake and the pressing element of the parking brake being attached to the same brake caliper.

This is understood to mean that the same brake caliper comprises the service brake and the parking brake, and the service brake and the parking brake have separate pressing elements, in order to press the brake lining against the brake disk, in order to achieve a braking action. The parking brake is understood, in particular, to be an automated parking brake (what is known as an APB).

Separate pressing elements are understood to be different pressing elements which exist functionally next to one another. There is therefore no common pressing element of the parking brake and the service brake. The pressing elements of the parking brake and the service brake can certainly act on the same brake lining, however.

The service brake and the parking brake are attached to the same brake caliper. This is understood to mean that merely one common brake caliper is provided both for the parking brake and the service brake. Here, the brake caliper serves to support the respective pressing elements.

Furthermore, components of the two brake systems can be integrated into the brake caliper or can be attached or fastened to the latter. In this context, the same brake caliper comprises components of the service brake and of the parking brake.

This is also understood to mean that there is a direct attachment of the pressing elements both of the service brake and the parking brake to the brake lining. There is therefore a structural independence of the pressing elements from one another and an independence in terms of their method of operation.

The wheel brake apparatus has, in particular, a brake caliper which is arranged so as to span a brake disk. This is understood to mean that the brake caliper can make an action on the brake surfaces of the brake disk from two sides possible. For this purpose, for example, the service brake is configured as a fixed caliper brake apparatus and has brake pistons on both brake caliper sides.

In one advantageous embodiment of the wheel brake apparatus, the pressing element of the parking brake and the pressing element of the service brake act on the same brake lining.

This is understood to mean that a pressing element of the service brake and a pressing element of the parking brake are pressed onto the same brake lining on one side of the wheel brake apparatus. All the pressing elements of the service brake and the parking brake can of course also act on one and the same brake lining on one side of the wheel brake apparatus. As an alternative, only a certain number of pressing elements act on the same brake lining.

In one possible refinement of the wheel brake apparatus, the pressing element of the service brake is configured as a brake piston.

In one preferred refinement of the wheel brake apparatus, at least two brake pistons are configured on one side of the wheel brake apparatus as pressing elements of the service brake.

This is understood to mean that the service brake comprises a plurality of pressing elements on one brake caliper side. For example, the brake caliper comprises two brake pistons on one side, in order to press the brake lining against the brake disk. In the case of a fixed caliper brake apparatus, the pressing elements are of mirrored configuration on the two brake caliper sides. That is to say, a brake caliper having two brake pistons of the service brake on one side actually has four pistons and, as a consequence, is called a four-piston caliper. In an analogous manner, a brake caliper with three or four brake pistons on one side is a six-piston or eight-piston caliper, respectively.

In one alternative development of the wheel brake apparatus, the pressing element of the parking brake is configured as a plunger. This is understood to mean that the parking brake has a pressing plunger which can be moved against the brake lining, in order to achieve a braking action between the brake lining and the brake disk.

In one advantageous embodiment, the wheel brake apparatus is configured in such a way that a direct introduction of force takes place from the pressing element of the parking brake to the brake lining.

This is understood to mean that the parking brake does not bring about a force on the brake lining via a pressing element of the service brake. The pressing element of the parking brake therefore does not act on the brake lining by means of the or one brake piston of the hydraulic service brake. Rather, the introduction of force of the parking brake takes place in a direct manner. The wheel brake apparatus is of corresponding configuration, in order to make this possible. To this end, in particular, a structural independence of the pressing elements of the parking brake and the service brake is provided. The positioning thereof is also to be selected accordingly. In this context, it might also be said that the parking brake and the service brake are of corresponding configuration, in order to achieve a direct introduction of force of the pressing element of the parking brake to the brake lining. As a result, a simplification of the complexity of the transmission of force is advantageously achieved.

In one possible embodiment of the wheel brake apparatus, said wheel brake apparatus is configured in such a way that the hydraulic system of the service brake has no infiltration by means of the parking brake.

This is understood to mean that the parking brake is not incorporated into the hydraulic system of the service brake. As a result, the complexity of a sealing means and a susceptibility to faults can advantageously be reduced.

In one preferred development, the wheel brake apparatus is configured in such a way that the hydraulic system of the service brake is configured outside the parking brake.

This is understood to mean that the service brake system does not comprise or integrate the parking brake structurally. As a result, the complexity of a sealing means and a susceptibility to faults can advantageously be reduced. Any configuration in spatial terms is conceivable, for example that the hydraulic system of the service brake surrounds the parking brake spatially on one brake caliper side.

In one alternative embodiment, the wheel brake apparatus is configured in such a way that the parking brake is configured outside the hydraulic system of the service brake. As a result, a sealing means of the force path of the parking brake and/or of the moving components of the parking brake is advantageously dispensed with.

In one possible embodiment, the wheel brake apparatus is configured in such a way that the pressing element of the parking brake is configured spatially between two pressing elements of the service brake.

This is understood to mean that the parking brake is positioned between two or more service brake pressing elements on one side of the brake caliper. For example, the pressing element of the parking brake can be configured or positioned in the center between two pressing elements of the service brake. This is not necessarily to be understood to mean an absolute geometric center, even if this is also conceivable. Rather, any intermediate position between at least two pressing elements is included. Here, there can also be deviations in terms of the height or there can be a closer orientation to one of the two adjacent pressing elements of the service brake.

In one preferred refinement of the wheel brake apparatus, the pressing element of the parking brake is positioned in such a way that its introduction of force takes place substantially at the centroid of the brake lining.

This is to be understood to mean that the parking brake is positioned with regard to the brake caliper and/or the brake lining in such a way that the pressing element of the parking brake acts on the centroid of the brake lining. The wheel brake apparatus including the integrated components is therefore configured in such a way that the introduction of force of the parking brake takes place at the centroid of the brake lining.

According to the disclosure, a brake caliper is provided which is configured for implementing a wheel brake apparatus in accordance with one of the described embodiments.

### BRIEF DESCRIPTION OF THE DRAWINGS

It is to be noted that the features which are mentioned individually in the description can be combined with one another in any desired, technically appropriate way and indicate further refinements of the disclosure. Further features and expediencies of the disclosure result from the description of exemplary embodiments using the appended figures.

FIG. 1 depicts a wheel brake apparatus according to the disclosure; and

FIG. 2 depicts at least one embodiment of a wheel brake apparatus according to the disclosure.

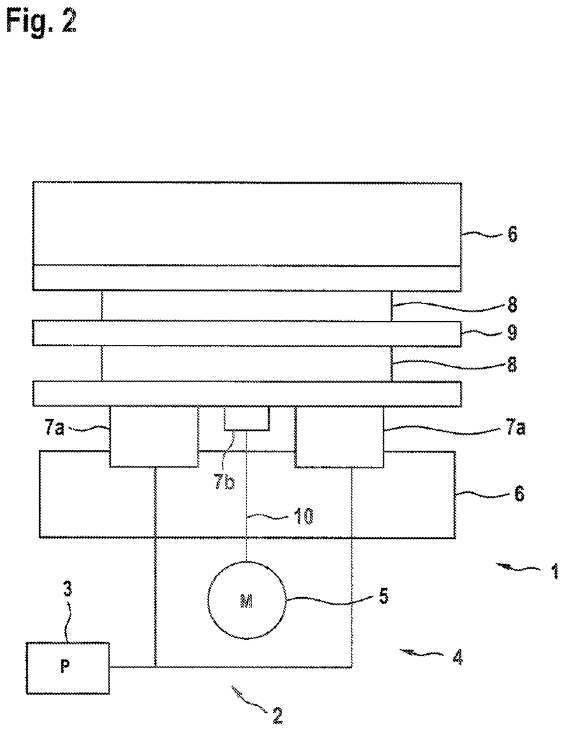

### DETAILED DESCRIPTION

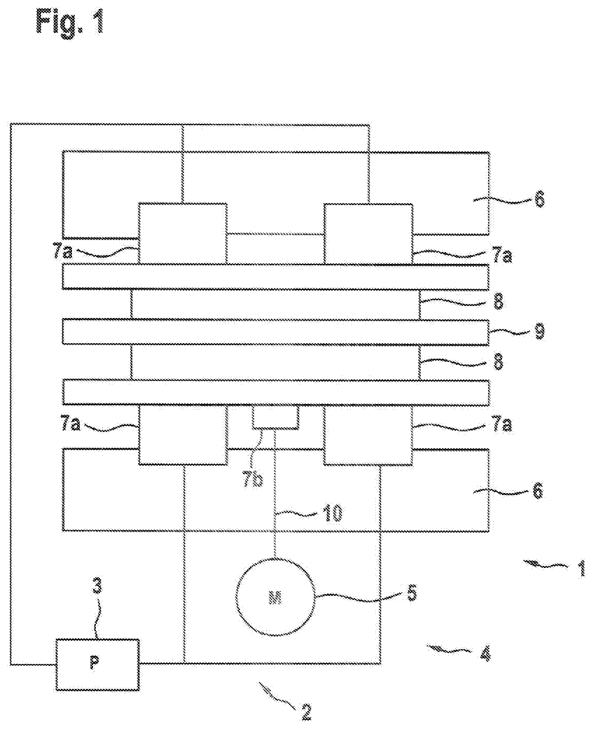

FIG. 1 shows a diagrammatic illustration of a wheel brake apparatus 1 for a vehicle. Here, the entire vehicle is not depicted. The wheel to be braked is likewise not shown. In contrast, the hydraulic service brake 2 having an actuator 3, for example a hydraulic pump, is shown. The actuator 3 generates a fluid shift or a fluid pressure. As a result, the pressing elements 7a of the service brake 2 are moved in the direction of the brake disk 9. Brake pistons, for example, can be understood to be pressing elements 7a. Here, the pressing elements 7a are mounted in the brake caliper 6. The brake caliper 6 also makes absorbing of the generated brake pressure possible. That is to say, in the case of an actuation, the brake pistons are supported against the brake caliper 6. The pressing elements 7a bear against a brake lining 8 and move the latter in the direction of the brake disk 9 in the case of an actuation. Ultimately, a braking action is generated by way of the pressing of the brake lining 8 onto the brake disk 9.

Furthermore, an electromechanical parking brake 4 having an actuator 5 is shown. The actuator 5 is configured, for example, as an electric motor. Via a transmission apparatus 10, the actuator 5 makes a force flow and/or a movement of a further pressing element 7b possible. The transmission apparatus 10 is configured, for example, as a spindle. In the case of an actuation of the electric motor, the pressing element 7b or a plunger is moved correspondingly. The pressing element 7b acts directly on the brake lining 8. A braking action is once again generated by way of the pressing of the brake lining 8 onto the brake disk 9.

Furthermore, only one side of the wheel brake apparatus 1 is shown. A brake apparatus of this type can be configured as a floating caliper brake or fixed caliper brake. These are alternatives which are known from the prior art and are therefore not shown explicitly. In both cases, the brake caliper 6 reaches over the brake disk 9. In the case of a floating caliper brake, a further brake lining is attached fixedly on the opposite brake caliper side (not shown). In order to achieve the braking action, the brake pistons 7a are actuated and press the brake lining 8 against a brake disk 9 which can be moved in a floating manner and in turn is pressed against the brake lining of the opposite brake caliper side. In the case of a fixed caliper brake, two brake pistons, for example, are likewise configured on the opposite brake caliper side (not shown). Said brake pistons move a further brake lining in the direction of the brake disk 9. In order to achieve a braking action, the brake pistons on both sides are actuated and press the brake linings against the brake disk 9.

The parking brake 4 is configured merely on one side of the brake caliper 6 of the present wheel brake apparatus 1.

What is claimed is:

1. A wheel brake apparatus configured to implement a first braking operation via a hydraulic service brake and configured to implement a second braking operation via an electromechanical parking brake, the wheel brake apparatus comprising:
at least two pressing elements configured for achieving a braking effect via pressing a brake lining against a brake disk; and
a brake caliper that supports the at least two pressing elements,
wherein the service brake includes at least one first pressing element of the at least two pressing elements and the parking brake includes a second pressing element of the at least two pressing elements, and
wherein the at least one first pressing element of the service brake and the second pressing element of the parking brake are attached to the same brake caliper.

2. The wheel brake apparatus according to claim 1, wherein the second pressing element of the parking brake and the at least one first pressing element of the service brake act on the same brake lining.

3. The wheel brake apparatus according to claim 1, wherein the at least one first pressing element of the service brake is configured as a brake piston.

4. The wheel brake apparatus according to claim 3, wherein the at least one first pressing element of the service brake includes at least two brake pistons arranged on one side of the wheel brake apparatus.

5. The wheel brake apparatus according to claim 1, wherein the second pressing element of the parking brake is configured as a plunger.

6. The wheel brake apparatus according to claim 1, wherein the wheel brake apparatus is configured such that a direct introduction of force occurs from the pressing of the second pressing element of the parking brake to the brake lining.

7. The wheel brake apparatus according to claim 1, wherein a hydraulic system of the service brake has no infiltration by the parking brake.

8. The wheel brake apparatus according to claim 1, wherein a hydraulic system of the service brake is arranged outside the parking brake.

9. The wheel brake apparatus according to claim 1, wherein the parking brake is arranged outside a hydraulic system of the service brake.

10. The wheel brake apparatus according to claim 1, wherein the second pressing element of the parking brake is arranged spatially between two first pressing elements of the at least one first pressing element of the service brake.

11. The wheel brake apparatus according to claim 1, wherein the second pressing element of the parking brake is positioned in such a way that an introduction of force of the second pressing element takes place substantially at a centroid of the brake lining.

12. A brake caliper for implementing a wheel brake apparatus, the brake caliper configured to:
support at least two pressing elements of the wheel brake apparatus, the wheel brake apparatus including the brake caliper and configured to implement a first braking operation via a hydraulic service brake and to implement a second braking operation via an electromechanical parking brake,
wherein the service brake includes at least one first pressing element of the at least two pressing elements and the parking brake includes a second pressing element of the at least two pressing elements, and
wherein the at least one first pressing element of the service brake and the second pressing element of the parking brake are attached to the brake caliper.
